(19) United States
(12) Patent Application Publication
(10) Pub. No.: US 2019/0003449 A1
(43) Pub. Date: Jan. 3, 2019

(54) A WAVE PANEL ASSEMBLY FOR AN APPARATUS FOR EXTRACTING ENERGY FROM MOVING WATER, AND A WAVE ENERGY EXTRACTING APPARATUS

(71) Applicant: WATERENERGY EXPLORER SCANDINAVIA AB, Stockholm (SE)

(72) Inventor: Michael Ågren, Bromma (SE)

(73) Assignee: WATERENERGY EXPLORER SCANDINAVIA AB, Stockholm (SE)

(21) Appl. No.: 15/576,735

(22) PCT Filed: May 27, 2015
(86) PCT No.: PCT/SE2015/050611

§ 371 Date: Nov. 24, 2017

(51) Int. Cl. F03B 13/18

(52) U.S. Cl. CPC F03B 13/182; F05B 2240/40

(57) ABSTRACT

A wave panel assembly (10) for a wave en-ergy extracting apparatus, comprising a base member (12) configured to be anchored to the bottom (14) of a water basin, and a wave panel (20) pivotably connected to the base member at a first lower end (22) of the wave panel by means of a pivot connection (16). The wave panel is configured to perform a reciprocating movement in relation to a pivoting axis of the pivot connection when the wave panel is located in water and is subjected to the influence of moving water, and the wave panel has a first side surface (24) configured to face away from the direction of movement W of the moving water and a second side surface (26) configured to face towards the direction W of movement of the moving water. The wave panel (20) is provided with a float member (18) arranged at the first side surface (24) of the wave panel, in a position between the first lower end (22) and a second top end (23) of the wave panel. Also disclosed is a wave energy extracting apparatus (50) comprising a wave panel assembly.

### TECHNICAL FIELD OF THE INVENTION

The present invention relates to an apparatus for extracting energy from moving water. In particular it relates to a wave panel assembly for such an apparatus. The apparatus is to be anchored at the bottom of a water basin and located in the water where it is activated by kinetic energy from moving water, e.g. from waves.

### BACKGROUND

It has long been recognised that the waves in the sea and other bodies of water offer a vast and substantially un-utilised energy source. Many inventions have been made with the aim of extracting power from the sea.

One type of wave energy apparatus is the type that is anchored to the bottom of a water basin. An example of this type of apparatus is described in WO 2004/007953. The apparatus comprises a wave energy absorbing panel that is mounted on a seabed-mounted support structure. The panel is mounted on a hinged lever arm and performs a reciprocating motion in order to absorb wave energy from the wave motion in the sea. For deepwater wavelengths of L, the panel is optimally positioned in a region within L/2 depth from the sea surface. The panel is coupled by a connecting rod to a fluid pump that generates a high pressure fluid output that may be used to drive a reverse osmosis desalination unit or to produce other useful work.

Another example of a wave energy apparatus of a similar type is described in WO 03/036081. The apparatus comprises a wave energy absorbing plate or panel that is attached to the bottom of a water basin in such a way that a reciprocating movement of the water mass actuates the plate. The plate is completely immersed in water. The plate is moved by the water mass and the kinetic energy of the plate is recovered into an energy reservoir under the water surface, e.g. a compression cylinder, which is attached to the plate, roughly at the plate's vertical centre. The rotational movement of the plate is transformed into a pumping movement of the cylinder, which is enhanced by the presence of a float at the top of the plate. The float has the function of continuously trying to bring back the plate to its upright, vertical position, after it has been hit by a wave.

In FIG. 1 is schematically illustrated the movements of a plate/panel 1 provided with a top float 2. When a moving water mass hits the side of the panel, the energy from the moving water makes the panel rotate in relation to the point where it is attached to bottom of the water basin. The panel then rotates back, in the other direction, past its upright position. The kinetic energy transferred from the moving water to the panel has a maximum when the panel is in its upright vertical position. The more the panel deviates from its vertical position, the less kinetic energy from the moving water is transferred to the panel, and the deviation will always be greater in the direction that the panel moves when first hit by the wave. From the example in FIG. 1 it can be seen that wave energy influences the panel between an angle of approximately −10° to approximately +40° in relation to the vertical. A negative angle indicates an inclination of the panel in a direction towards the direction of movement W of the water and a positive angle indicates an inclination of the wave panel away from the direction of movement of the water.

### SUMMARY OF THE INVENTION

An object of the present invention is to improve the energy utilisation in an apparatus having a wave panel that is actuated by kinetic energy from moving water when hit by the moving water.

According to the present invention is defined a wave panel assembly for a wave energy extracting apparatus, comprising a base member configured to be anchored to the bottom of a water basin, a wave panel pivotably connected to the base member at a first lower end of the wave panel by means of a pivot connection, the wave panel being configured to perform a reciprocating movement in relation to a pivoting axis of the pivot connection when the wave panel is located in water and is subjected to the influence of moving water, and the wave panel having a first side surface configured to face away from the direction of movement of the water and a second side surface configured to face towards the direction of movement of the water, characterized in that the wave panel is provided with a float member arranged at the first side surface of the wave panel, in a position between the first lower end and a second top end of the wave panel.

By arranging a float member at the side surface of the wave panel, on the side that is configured to face away from the direction of movement of the water, the wave panel will have a rest position, where it is not influenced by any force from moving water, that is inclined towards the side that does not have the float member. Or in other words, the rest position of the wave panel can be described as being biased towards the direction from where it will be hit by the moving water. This will result in an improved energy transfer of the kinetic energy from the water to a movement of the wave panel since the reciprocating movement of the wave panel will be more evenly centred around the vertical direction, i.e. around an approximately perpendicular angle to the water surface. According to water wave theory, the energy of the moving water has its maximum at an angle perpendicular to the bottom of the water basin, under the presumption that the bottom of the water basin is flat and horizontal, i.e. not inclined, and consequently, the more the movement of the wave panel is centred around the perpendicular angle, the better the effect. Alternatively, this can be expressed as the energy of the moving water having its maximum at an angle perpendicular to the water surface. In the context of the present patent application, the expression “vertical direction of the wave panel” should be understood to correspond to an angle of the wave panel that is perpendicular to the general water surface. Or in other words, the totally upright, vertical position of the wave panel when it is not subjected to any side forces.

According to one feature, the float member may extend essentially along the entire width of the first side surface of the wave panel. This will provide for an even distribution of the effect of the float member.

According to another feature, the float member may be adjustably arranged at the first side surface of the wave panel. By making it possible to adjust the location of the flat member and to move the float member up or down, the effect of the float member can varied in order to obtain the most advantageous result for a certain case.

According to another feature, the float member may have a cylindrical shape. The cylindrical shape is both practical from a mechanical point of view and is advantageous from a flow point of view. However, other shapes can also be foreseen.

According to a further feature, the float member may be arranged to incline the wave panel, in a rest position, in a direction towards the direction of movement of the moving water, at an angle of approximately −5° to approximately −40° in relation to a vertical position of the wave panel. Preferably, the angle is between −5° and −30°, and more preferably between −5° and −20°.

Generally, in the context of the present invention, a negative angle of the wave panel in relation to the vertical direction indicates an inclination of the panel in a direction towards the direction of movement of the moving water and a positive angle indicates an inclination of the wave panel away from the direction of movement. This can be clearly seen in the figures.

According to yet another feature, the wave panel may be arranged to perform a reciprocating movement between an angle of approximately −45° and an angle of approximately +55° in relation to a vertical position of the wave panel. Preferably, the wave panel is arranged to oscillate between an angle of approximately −35° and approximately +45°, and even more preferably between an angle of approximately −20° and approximately +30°. Different angles can be foreseen depending on different wave conditions.

According to one embodiment, the float member may be arranged on the first side surface of the wave panel. By arranging the float member directly on the side surface a simple construction is obtained. By mounting the float member high up on the side surface the wave panel will be more influenced by the float force and its turning angle will increase, and by choosing to mount the float member lower down its effect will be lesser and the turning angle will be smaller.

According to another embodiment, the float member may be arranged at a distance from the first side surface of the wave panel. By moving out the float member such that it is located at a distance from the wave panel, the inclination of the wave panel will increase, the wave will hit the wave panel earlier and the turning angle of the wave panel in relation to the vertical will increase which is advantageous.

According to another aspect of the present invention is defined a wave energy extracting apparatus comprising a wave panel assembly according to any one of the claims defining a wave panel assembly, and further comprising an arrangement for extracting energy generated by the movement of the wave panel. The wave panel assembly of the present invention can be used together with many different types of arrangements for extracting energy generated by the movement of the wave panel. Examples of such arrangements are found in WO 03/036081, WO 2004/007953, WO 2004/097212.

In WO 03/036801, the kinetic energy of a wave panel is transferred by means of a piston, attached to the side of the wave panel, into a compression cylinder acting as an energy reserve. The compressed medium, which is air in the described case, can subsequently be used for the desired purpose, for example in a water-lifting arrangement. In WO 2004/007953 a torsion pump is used and the wave panel is attached to the pivoting shaft of the torsion pump. In WO 2004/097212 is described how the wave panel motion is coupled by a connecting rod to a fluid pump. Thus, the reciprocating movement of the wave panel can be transformed into energy in many ways. The means for extracting electric energy can comprise, for instance, an arm articulated in a wave panel, the arm having means for being connected over a lever system to an electric generator thereby allowing energy to be transformed into electricity. If the kinetic energy of the reciprocating movement is transformed into kinetic energy of a rotating movement, this can be directly transformed into electricity by means of a generator.

Generally, apparatuses that extract kinetic energy from moving water are referred to as wave energy extracting apparatuses, even though the movement of water may be the result of other phenomenon than waves, e.g. swells, underwater streams etc. which generate a movement of the water. The term wave energy extracting apparatus should therefore, whenever used in this patent application, be interpreted to mean an apparatus that extracts kinetic energy from moving water in general, and not be restricted to waves. In analogy, the expression wave panel should be interpreted as any panel that can be used in a wave energy extracting apparatus in order to extract kinetic energy from moving water, without any limitation to waves.

Further features and advantages of the invention will also become apparent from the following detailed description of embodiments.

### BRIEF DESCRIPTION OF THE DRAWINGS

The invention will now be described in more detail, with reference being made to the enclosed schematic drawings illustrating different aspects and embodiments of the invention, given as examples only, and in which:

FIG. 1 illustrates schematically the principle of an apparatus for extracting wave energy according to prior art,

FIG. 2 illustrates schematically a wave panel assembly according to the present invention,

FIG. 3 illustrates schematically an embodiment of a wave panel assembly according to the present invention,

FIG. 4 illustrates schematically another embodiment of a wave panel assembly according to the present invention,

FIG. 5a illustrates schematically an embodiment of a wave energy extracting apparatus according to the present invention, and

FIG. 5b illustrates schematically another embodiment of a wave energy extracting apparatus according to the present invention.

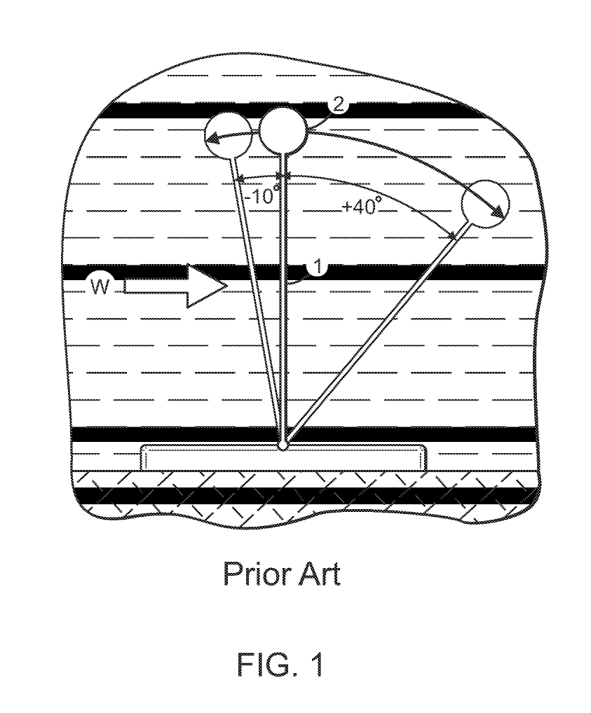

Elements that are the same or represent corresponding or equivalent elements have been given the same reference numbers in the different figures.

### DETAILED DESCRIPTION

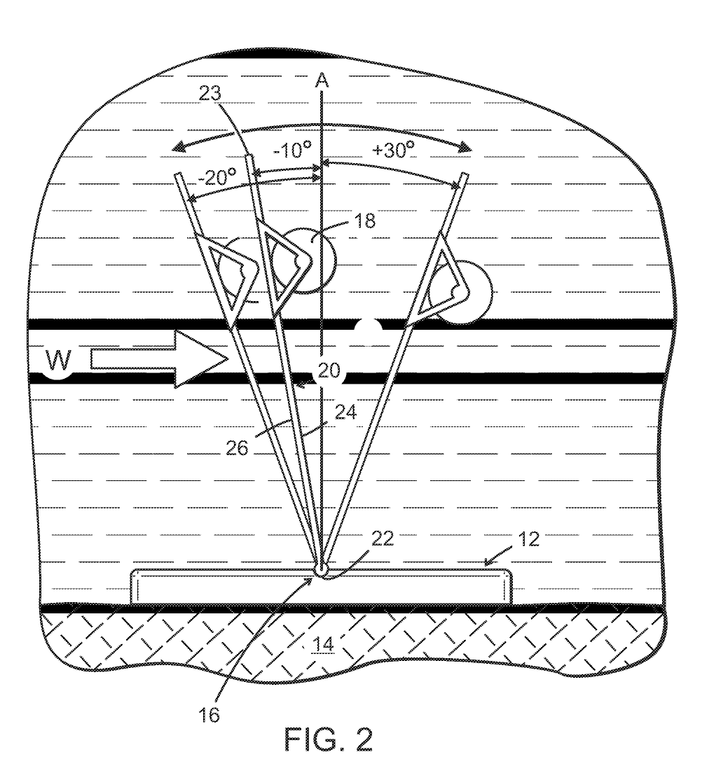

In FIG. 2 is shown a wave panel assembly 10 according to the invention. The wave panel assembly is designed to constitute a part of a wave energy extracting apparatus, as will be described later. The wave panel assembly 10 comprises a base member 12 configured to be anchored to the bottom 14 of a water basin. The wave panel assembly further comprises a wave panel 20 pivotably connected to the base member 12, at a first lower end 22 of the wave panel, by means of a pivot connection 16. The pivot connection may for example be a hinge connection or any other suitable connection allowing the wave panel to pivot about a pivot axis of the pivot connection. The wave panel 20 is configured to perform a reciprocating movement in relation to a pivoting axis of the pivot connection 16 when the wave panel is located in water and is subjected to the influence of moving water. The wave panel has a first side surface 24 configured to face away from the direction of movement W of the moving water and a second side surface 26 configured to face towards the direction of movement W of the moving water.

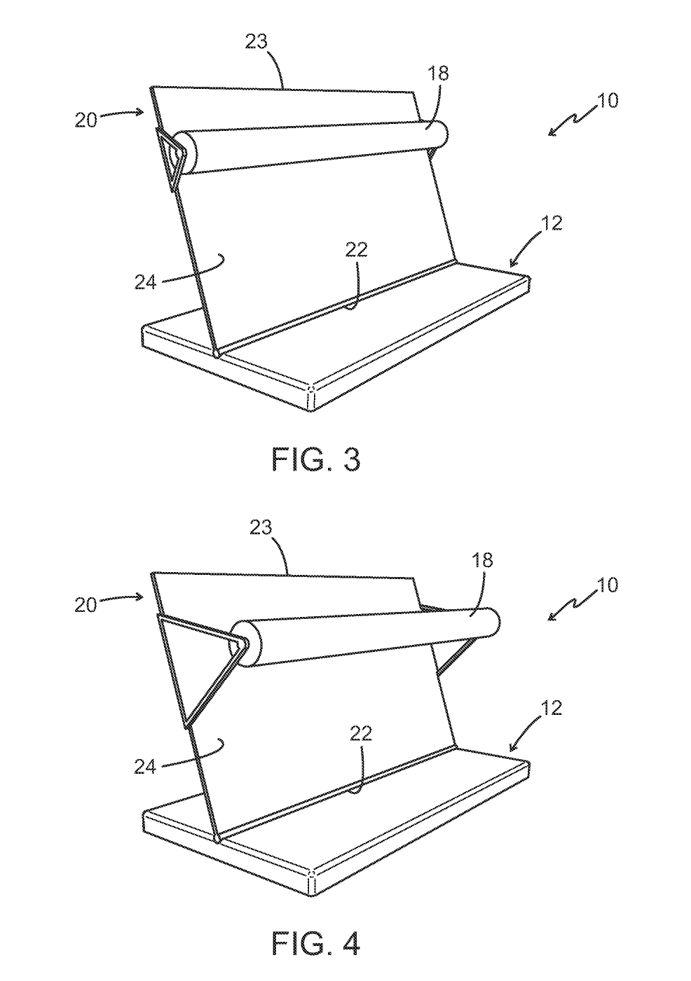

The wave panel assembly 10 further comprises a float member 18 that is arranged at the first side surface 24 of the wave panel, between a first lower end 22 of the wave panel and a second top end 23 of the wave panel. The float member 18 can be mounted such that it is in contact with the side surface 24 or very close to the side surface, as shown in FIG. 3, or it can be mounted at a distance from the side surface, as shown in FIG. 4. If the float member is mounted relatively high up, the impact will be greater than if it is mounted lower down. Also, if the float member is arranged at a distance away from the wave panel, a longer distance will increase the impact of the float. Even if the wave panel for some reason should not be entirely immersed in the water, e.g. if the top of the wave panel surfaces above the water, the float member should always be located such that it is immersed in water.

The function of the float member is illustrated in FIG. 2. By arranging a float member 18 at the side surface 24 of the wave panel 20, on the side that is configured to face away from the direction of movement W of the moving water, the wave panel 20 will have a rest position, i.e. a position in which it is not influenced by any force from the moving water, that is inclined in the direction towards the other side of the wave panel 20 that does not have a float member. Or in other words, the rest position of the wave panel 20 can be described as being inclined and biased towards the direction from where it will be hit by the moving water. This will result in an improved energy transfer of the kinetic energy from the moving water to a movement of the wave panel 20 since the reciprocating movement of the wave panel 20 will be more evenly centred around the vertical direction A, i.e. around an approximately perpendicular angle to the bottom of the water basin and also the water surface. As already explained above, the energy of the moving water has its maximum at an angle perpendicular to the bottom of the water basin/water surface, and consequently, the more the movement of the wave panel is centred around the perpendicular angle, the better the effect.

In the illustrated example in FIG. 2, the float member is located such that the angle of the rest position for the wave panel 20 is −10° in relation to the vertical direction A. This will result in a pivoting movement of the wave panel 20, when hit by a wave, such that it will rotate past the vertical A and over to the opposite side of the vertical to a maximum angle of +30°, and then back past the vertical A and past the rest position angle, to an approximate angle of −20° where it will reverse its direction again. It should be noted that the figures for the angles are only illustrative examples, and can vary substantially due to factors such as the height position and size of the float member 18, the distance of the float member 18 from the wave panel 20, the weight of the wave panel, details of the pivot connection 16 etc., and not least the water movement. It can be foreseen that the angle for the rest position can be of approximately −5° to approximately −40° in relation to a vertical position of the wave panel. Preferably, the angle is between −5° and −30°, and more preferably between −5° and −20°. With regard to the end points for the pivoting movement, it can be foreseen that the wave panel is arranged to perform a reciprocating movement between an angle of approximately −45° and an angle of approximately +55° in relation to a vertical position of the wave panel, preferably between an angle of approximately −35° and approximately +45°, and even more preferably between an angle of approximately −20° and approximately +30°.

The location of the float member 18 in relation to the wave panel 20 may vary since this has an impact on the rest position angle of the wave panel, as already mentioned. In FIG. 3 is schematically illustrated an embodiment where the float member is mounted directly on the first side surface 24 of the wave panel 20. In FIG. 4 is illustrated another embodiment in which the float member 18 is mounted such that it is located at a distance from the first side surface 24 of the wave panel 20.

The float member may also be adjustably arranged in the sense that it may be moved up or down in relation to the wave panel. Usually such an adjustment would be made before the wave panel assembly is installed in the water.

The wave panel assembly 10, according to the invention, can be used together with many different types of arrangements that extract the energy generated by the movements of the wave panel in order to make it possible to utilise the energy of the moving water in many different applications. Examples of such energy extracting apparatuses can involve different types of pump arrangements.

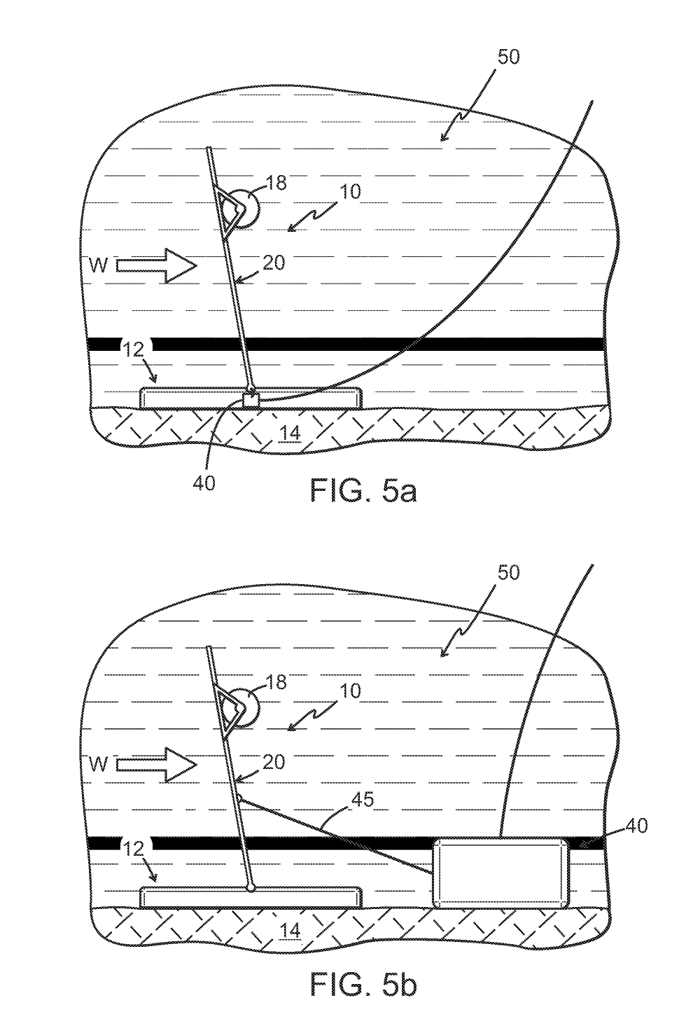

In FIG. 5a is schematically illustrated one possible embodiment of a wave energy extracting apparatus 50 comprising a wave panel assembly 10 according to the invention and an arrangement 40 for extracting energy generated by the movement of the wave panel. The energy extracting arrangement 40 comprises a torsion pump and the wave panel is attached to the pivoting shaft of the torsion pump. The kinetic energy of the reciprocating movement of the wave panel is thus transformed into kinetic energy of a rotating movement, and this can for example be directly transformed into electricity by means of a generator.

In FIG. 5b is schematically illustrated another possible embodiment of a wave energy extracting apparatus 50 comprising a wave panel assembly 10 according to the invention and an arrangement 40 for extracting energy generated by the movement of the wave panel. The energy extracting arrangement 40 comprises an arm 45 articulated in a wave panel, the arm having means for being connected to a compression cylinder acting as an energy reserve or being connected over a lever system to an electric generator thereby allowing energy to be transformed into electricity. A large pivoting movement of the wave panel 20 will have a large impact on the energy extracting arrangement 40, since the reciprocating movement of the arm 45 will be large. The invention shall not be considered limited to the illustrated embodiments, but can be modified and altered in many ways, as realised by a person skilled in the art, without departing from the scope defined in the appended claims.

1-9. (canceled)

10. A wave panel assembly for a wave energy extracting apparatus, comprising a base member configured to be anchored to the bottom of a water basin and a wave panel pivotably connected to the base member at a first lower end of the wave panel by means of a pivot connection, the wave panel being configured to perform a reciprocating movement in relation to a pivoting axis of the pivot connection when the wave panel is located in water and is subjected to the influence of moving water, and the wave panel having a first side surface configured to face away from the direction of movement W of the moving water and a second side surface configured to face towards the direction W of movement of the moving water, wherein the wave panel is provided with afloat member arranged at the first side surface of the wave panel, in a position between the first lower end and a second top end of the wave panel, wherein the float member is arranged to incline the wave panel, in a rest position, in a direction towards the direction of movement W of the water at an angle of approximately −5° to approximately −40° in relation to a vertical position A of the wave panel.

11. The wave panel assembly according to claim 10, wherein the float member extends essentially along the entire width of the first side surface of the wave panel.

12. The wave panel assembly according to claim 10, wherein the float member is adjustably arranged at the first side surface of the wave panel.

13. The wave panel assembly according to claim 10, wherein the float member has a cylindrical shape.

14. The wave panel assembly according to claim 10, wherein the wave panel is arranged to perform a reciprocating movement between an angle of approximately −45° and an angle of approximately +55° in relation to a vertical position of the wave panel.

15. The wave panel assembly according to claim 10, wherein the float member is arranged on the first side surface of the wave panel.

16. The wave panel assembly according to claim 10, wherein the float member is arranged at a distance from the first side surface of the wave panel.

17. A wave energy extracting apparatus comprising a wave panel assembly according to claim 10, and further comprising an arrangement for extracting energy generated by the movement of the wave panel.
